(19) United States
(12) Patent Application Publication
(10) Pub. No.: US 2023/0132939 A1
(43) Pub. Date: May 4, 2023

(54) INSTALLATION FOR TREATING CONTAINERS AND METHOD FOR CHANGING FORMAT

(71) Applicant: SIDEL PARTICIPATIONS, Octeville-sur-mer (FR)

(72) Inventor: Cedric BIANCHINI, OCTEVILLE-SUR-MER (FR)

(21) Appl. No.: 16/500,804

(22) PCT Filed: Mar. 29, 2018
(86) PCT No.: PCT/EP2018/058238

§ 371 Date: Oct. 3, 2019

(30) Foreign Application Priority Data
Apr. 3, 2017 (FR) 1752846

(51) Int. Cl. B67C 7/00; B08B 9/08; B67C 3/02; B67C 3/00

(52) U.S. Cl. CPC B67C 7/002; B08B 9/08; B67C 3/023; B67C 7/0046; B67C 3/001; B67C 2003/227

(57) ABSTRACT

The invention relates to an installation for treating a series of containers, comprising a machine for the initial treatment of the series of containers, in which the series of containers is subjected to an initial treatment between; a first additional treatment machine and a second additional treatment machine, each being arranged such that at least some of the series of containers that have been subjected to the initial treatment are subjected to an additional treatment in the first and/or second additional treatment machine; a first transfer device designed to remove the series of containers to an exit point of the initial treatment machine and distribute them to an entry point of the first and/or second additional treatment machine. Also included is a method for changing a treatment applied to containers by a treatment installation.

The invention concerns the field of the production of containers (in particular bottles, flasks) by forming preforms made of plastic material, such as polyethylene terephthalate (PET) for example, the containers being filled with a filling product.

In a production installation of the above kind there are combined for example the forming of the containers from preforms and the filling of those containers in continuity with the production of the containers. A production installation of this kind therefore generally includes a forming machine forming the containers from preforms and a filling machine filling the formed containers, a transfer device being adapted to take up the containers at the exit from the forming machine and to transmit them to the entry of the filling machine.

An installation of this kind must be cleaned regularly in order to prevent all risk of contamination of the containers or if the filling product is replaced by another product. In this case, the installation must be stopped even though only the filling machine is to be cleaned, for example. The production of filled containers is therefore halted during cleaning. This disadvantage may represent a serious penalty if the quantity of containers to be filled continuously with the same product and/or the same container is relatively small. This generates frequent changes of format. This situation arises in particular for the treatment of containers for shampoo type products or body care products. In this situation, the production downtime for cleaning the installation during the change of format greatly degrades the average production rate.

An installation of the above kind can also produce only containers filled with only one filling product, the installation having to be stopped for the filling product to be changed. Moreover, an installation of the above kind is also not satisfactory in the situation where a container must be filled with two different products, in particular products requiring different filling technologies, for example if the end product contained in the container results from mixing products from among: a very viscous product, a fluid product, or a product having particles incorporated in a liquid.

More generally, a container treatment installation does not function optimally if one treatment machine operates with a limited production throughput while another treatment machine is able to function with a higher treatment throughput. In fact, the treatment throughput is then limited by the treatment throughput of the treatment machine having the lowest treatment throughput.

One object of the invention is to propose a treatment installation able to function continuously even during cleaning. Another object of the invention is to increase the treatment throughput and/or to reduce the overall size of the installation, in particular if the succession of treatments to be carried out involves different treatment rates. Another object of the invention is to improve the flexibility on the installation without multiplying the overall size and/or the financial investment required for that flexibility.

To this end, the invention concerns an installation for treating a succession of containers, comprising:

at least one machine for the initial treatment of the succession of containers, in which the succession of containers is subjected to an initial treatment between an entry point and an exit point of said initial treatment machine,

at least one first additional treatment machine and one second additional treatment machine for the additional treatment of the succession of containers, each being arranged such that at least some of the succession of containers that have been subjected to the initial treatment are subjected to an additional treatment in the first additional treatment machine and/or in the second additional treatment machine, said additional treatment being applied between an entry point and an exit point of each of said first and second additional treatment machines,

at least one first transfer device adapted to take up the succession of containers at the exit point of the initial treatment machine and to distribute them selectively to the entry point of the first and/or the second additional treatment machine.

According to the invention the treatment installation is equipped with:

a first exit from the installation through which containers treated by the first additional treatment machine can exit, and

a second exit from the installation through which containers treated by the second additional treatment machine can exit, the first exit and the second exit from the installation being separate from one another.

Providing two additional treatment machines enables treatment to continue when one of the additional treatment machines is being cleaned. Having separate installation exits for each of the additional treatment machines enables cleaning up to and including that exit, in particular in the event of an incident at the treated container exit. Moreover, if the initial treatment machine is faster than the additional treatment machines, the overall treatment throughput may be increased by having the two additional treatment machines in operation. Moreover, the flexibility of the installation is increased. Each additional processing machine may be used to apply a different treatment to some of the containers. In the active configuration, the second transfer device further enables two successive additional treatments to be applied to the succession of containers.

According to another feature of the treatment installation, the latter is equipped with an isolation assembly comprising a plurality of mobile walls, the isolation assembly being adapted to be actuated at least between:

a first isolation configuration in which at least some of the walls define a first enclosure isolating the first additional treatment machine from an assembly including the initial treatment machine, the first transfer device and the second additional treatment machine, and

a second isolation configuration in which at least some of the walls define a second enclosure isolating the second additional treatment machine from an assembly including the initial treatment machine, the first transfer device and the first additional treatment machine.

The isolation assembly enables isolation of one additional treatment machine from the rest of the treatment installation and therefore entirely safe cleaning of the additional treatment machine with no risk of introducing harmful products, such as cleaning products, into the rest of the treatment installation.

According to another feature of the treatment installation:

the first additional treatment machine includes a first transfer station mobile between a transfer position in which the first transfer station enables movement of at least some of the succession of containers from the first transfer device to first additional treatment stations of the first additional treatment machine and a retracted position in which the first transfer station is placed in the first enclosure in the first isolation configuration, and/or

the second additional treatment machine includes a second transfer station mobile between a transfer position in which the second transfer station enables movement of at least one some of the succession of containers from the first transfer device to second additional treatment stations of the second additional treatment machine and a retracted position in which the second transfer station is placed in the second enclosure in the second isolation configuration.

The first and second transfer stations enable physical separation of the additional treatment machine that is to be isolated in order to enable the installation of the enclosure.

According to other features of the treatment installation according to the invention, separately or in combination:

the installation further includes a second transfer device adapted to be actuated between an inactive configuration and an active configuration, the second transfer device when in the active configuration being adapted to take up the succession of containers at the exit point of the first additional treatment machine and to transfer them to the second additional treatment machine,

the installation has a successive treatment configuration in which the isolation assembly also has a retracted configuration in which the second transfer device is in the active configuration,

the initial treatment machine is a machine for forming a succession of preforms into a succession of containers, said succession of preforms being introduced into said forming machine at the entry point and the succession of containers being taken up from said forming machine by the first transfer device at the exit point,

the forming machine includes a rotatable forming wheel carrying a plurality of stations for forming containers each adapted to receive a preform and to form said preform into a container between the entry point and the exit point,

two successive forming stations are adapted to form containers that are either different in a differentiated treatment configuration of the installation or identical in a parallel treatment configuration of the installation,

the first and second additional treatment machines are container filling machines adapted to introduce a product into the fraction of the succession of containers introduced into each of said filling machines,

the first and second additional treatment machines are adapted to introduce a different product into the containers transported in the first and second additional treatment machines,

the first and second additional treatment machines are filling machines using different filling techniques selected from volumetric, decimetric or weight-based filling,

the first additional treatment machine is adapted to introduce a first product into the succession of containers transported in said first machine and the second additional treatment machine is adapted to introduce a second product into said succession of containers containing said first product in a complementary filling configuration of the installation.

The invention is particularly advantageous when the initial treatment machine is a machine for forming containers and the additional treatment machines are filling machines. In fact, in this case, different operating modes may be envisaged, namely:

differentiated treatment of the containers, for example if a succession of containers is filled differently either because of the nature of the filling product or because of the filling method etc. It is therefore possible to obtain two types of containers at the exit of the installation from only one forming machine;

accelerated treatment of the containers by using two filling machines instead of one, as in conventional installations. The production throughput can therefore be increased;

successive treatment of the containers by placing the second transfer device in the active position, which enables the containers to be filled with a first product and then with a second product;

continuous treatment. In fact, one filling machine can be cleaned, for example when it is required to change the filling product, without stopping the installation, thanks to the other filling machine. The loss of productivity is therefore limited.

According to another feature of the treatment installation according to the invention the first transfer device includes elements for holding containers distributed at the periphery of a rotatable transfer wheel, each holding element being adapted to take up a container at the exit point of the initial treatment machine, two successive holding elements being respectively adapted to deliver one transported container to the first additional treatment machine and the other to the second additional treatment machine.

In another aspect, the invention also relates to a method for changing a treatment applied to containers by a treatment installation, the treatment applied including at least one initial treatment followed by at least one additional treatment,

the method using an installation comprising:

at least one machine for initial treatment of the succession of containers,

at least one first additional treatment machine adapted to apply a first additional treatment and a second additional treatment machine adapted to apply a second additional treatment, each adapted so that at least some of the succession of containers that have undergone the initial treatment undergo the first additional treatment and/or the second additional treatment,

a first transfer device forming a switch adapted to distribute the containers of the succession of containers to at least one first exit point and/or one second exit point separate from one another in accordance with a predetermined distribution sequence,

an isolation assembly comprising a plurality of mobile walls, the isolation assembly being adapted to be actuated at least between:

a first isolation configuration in which at least some of the walls define a first enclosure isolating the first additional treatment machine from an assembly including at least the initial treatment machine and the second additional treatment machine, and

a second isolation configuration in which at least some of the walls define a second enclosure isolating the second additional treatment machine from an assembly including at least the initial treatment machine and the first additional treatment machine,

the method including a passage

from an earlier phase in which the installation is in the second isolation configuration and the distribution sequence distributes the containers that have received the initial treatment in their entirety to the first additional treatment machine,

to a later stage in which the installation is in the first isolation configuration and the distribution sequence distributes the containers that have received the initial treatment in their entirety to the second additional treatment machine,

in which method the earlier phase includes a step of verifying that the second enclosure satisfies cleanliness criteria required for application of the second treatment, the containers treated during the earlier phase exiting the installation via a first exit in the part of the walls defining the first enclosure,

and the later phase includes a step of cleaning the first enclosure, the containers treated during the later phase exiting the installation via a second exit in the part of the walls defining the second enclosure.

Other aspects and advantages of the invention will appear on reading the following description given by way of example and with reference to the appended drawings, in which:

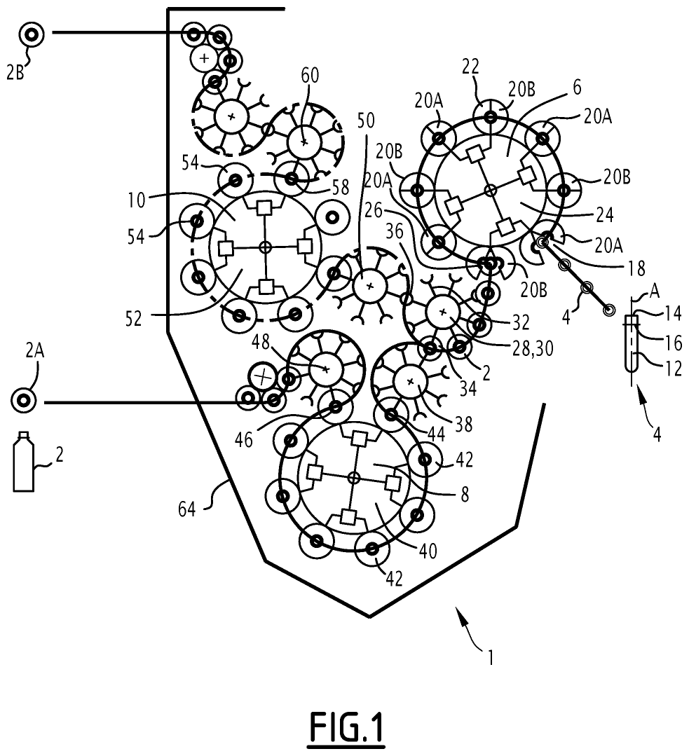

FIG. 1 is a diagrammatic representation of a treatment installation according to the invention as seen above, the treatment installation being in a differentiated filling configuration or in a parallel treatment configuration, each of the first and second transfer stations being in its transfer position.

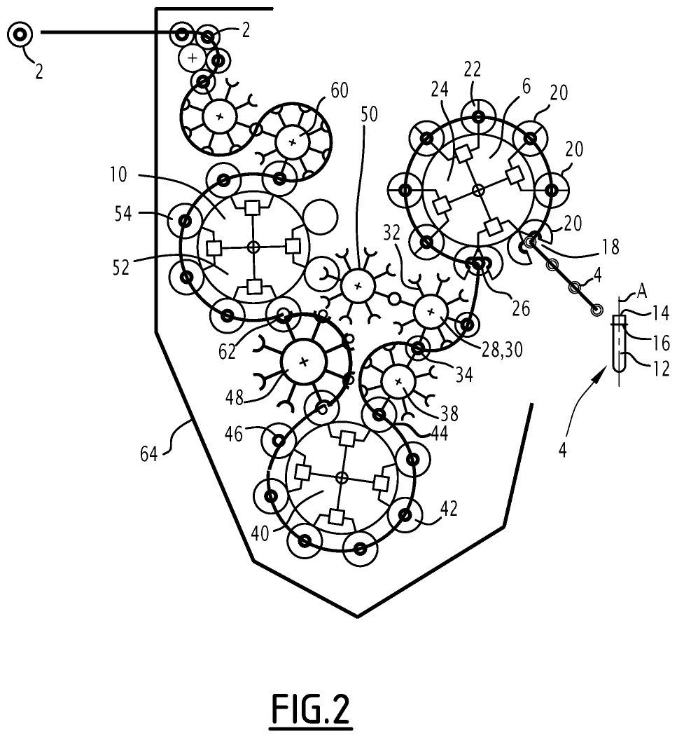

FIG. 2 is a diagrammatic representation of the treatment installation from FIG. 1, the treatment installation being in a complementary filling configuration. The first transfer station is in its transfer position and the second transfer station is in its retracted position. The isolation assembly is in a retracted configuration.

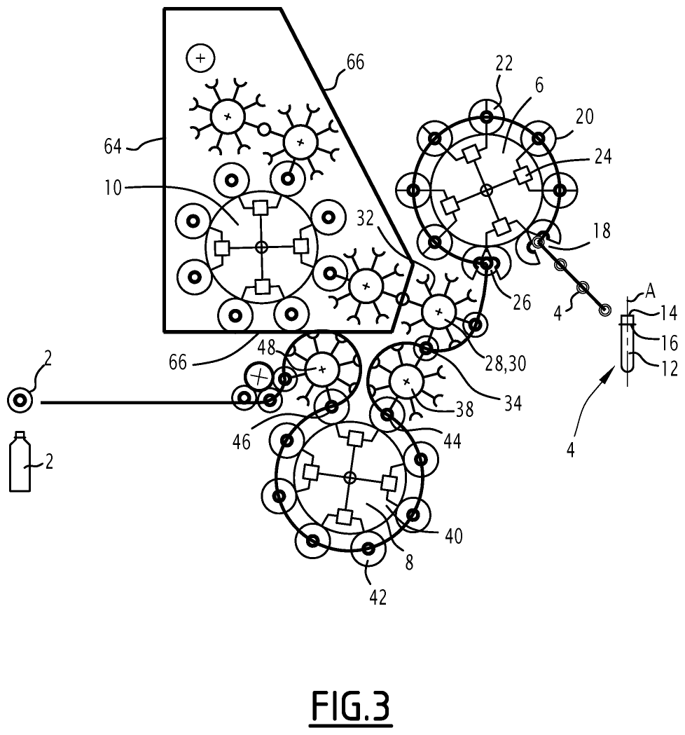

FIG. 3 is a diagrammatic representation of the treatment installation from FIG. 1 during cleaning of the second additional treatment machine, the isolation assembly being in the second isolation configuration. The first transfer station is in its transfer position and the second transfer station is in its retracted position.

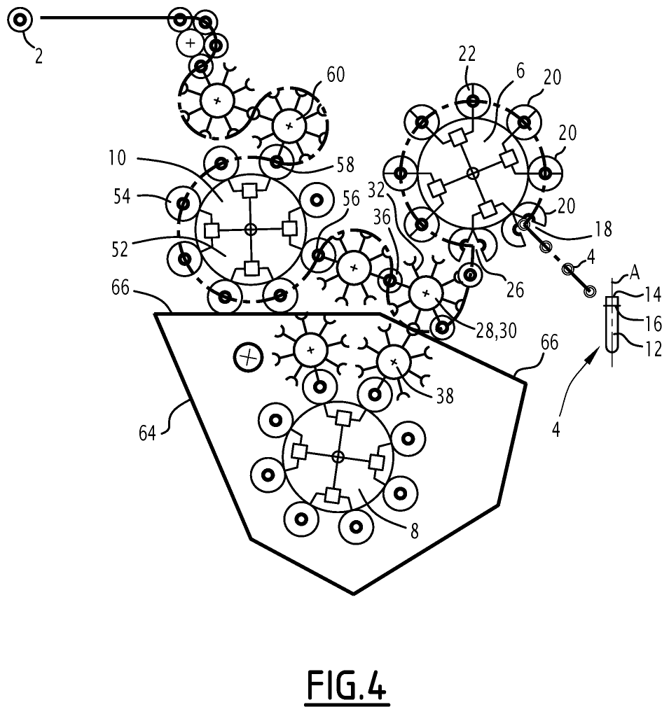

FIG. 4 is a diagrammatic representation of the treatment installation from FIG. 1 during cleaning of the first additional treatment machine, the isolation assembly being in the first isolation configuration. The first transfer station is in its retracted position and the second transfer station is in its transfer position.

An installation 1 for treating a succession of containers 2 is described with reference to FIGS. 1 to 4. The description covers the situation in which the treatment installation is an installation for producing a succession of containers from a succession of plastic material preforms 4. However, the invention concerns any type of treatment of containers, in particular: forming, labeling, marking, filling, rinsing of the containers or treatment of the walls of the containers, or treatment of a part of each container or of some containers, such as cooling the point of injection of the preform from which the container is obtained, or the specific deformation of a part of the container.

The treatment installation 1 includes at least an initial treatment machine 6, a first additional treatment machine 8 and a second additional treatment machine 10. Although the invention as described hereinafter applies to any type of container treatment machine the following description refers to the situation in which the initial treatment machine 6 is a machine for forming containers 2 from preforms 4 and in which the first and second additional treatment machines are machines for filling the containers 2.

Each preform 4 comprises a body 12, a neck 14 and a ring 16. The body 12 is the shape of a test tube for example, with a closed bottom, and defines an internal volume extending along a principal axis A. The neck 14 extends in continuity with the body 12 at the end opposite the bottom and forms an upper opening through which a fluid can be introduced into the internal volume of the preform, as described hereinafter. The neck 14 of the preform has for example the final shape that it will have in the container 2 formed from the preform 4 and includes, for example, a thread on its external wall to enable the fixing of a cap to the container. The ring 16 extends radially outward between the body 12 and the neck 14 and forms for example a transport ring by means of which the preform can be picked up and transported, as described hereinafter. The preform shape described above is described by way of example only and other shapes could be envisaged provided that they are appropriate for forming a container by introduction of a fluid into the preform. For example, the preform could therefore have a smooth neck, have no ring, and/or have other variant forms in accordance with diverse preform designs adapted to be used in the treatment installation 1. The plastic material of the preform is for example polyethylene terephthalate (PET). Alternatively, the plastic material could be other than PET, provided that said material can be made malleable and deformable to enable the production of a container by introduction of a fluid into the preform.

In known manner, before being formed into containers 2, the preforms 4 are heated in a heating station (not shown), for example an oven. The heating station is adapted to heat each preform 4 to a reference temperature at which the preform 4 is in a malleable state and can be formed into a container. The reference temperature is between the glass transition temperature and the crystallization temperature of the material of the preform 4.

At the exit from the heating heating station the heated preforms 4 are moved to an entry point 18 of the initial treatment machine 6.

In the case of a machine for forming containers 2 the initial treatment machine 6 comprises a plurality of forming stations 20 each adapted to receive and to form a preform 4 from the succession of preforms 4 into a container. To this end, each forming station 20 includes a mold 22 and a device for injecting a forming fluid. The mold 22 includes a molding cavity having the shape of the container to be produced and adapted to receive the body 12 of the preform. The injection device is adapted to inject a forming fluid under pressure into the internal volume of the preform 4 via the top opening of the latter in order for the body 12 of the preform to acquire the shape of the molding cavity. The forming fluid is for example a gas, for example compressed air. Each forming station 20 may further include a stretching rod adapted to press on the bottom of the preform 4 in order to stretch it along its axis A.

The forming stations 20 are for example carried by a forming wheel 24, or carousel, rotatable about a rotation axis, for example parallel to the axes A of the preforms 4 when they are in the initial treatment machine 6. The forming stations 20 are carried at the periphery of the forming wheel 24 so that they are moved along a circular path defined by the forming wheel 24 between the entry point 18 and an exit point 26. At the entry point 18 the mold is open and is adapted for receive a preform 4, after which the mold 22 is closed, the injection device is placed in fluidic communication with the internal volume of the preform, and the forming fluid is injected into the preform during the movement of the forming station between the entry point 18 and the exit point 26. At the exit point 26 the mold 22 is opened and the formed container is extracted from the forming station 20.

In one embodiment all the forming stations 20 and in particular the molding cavities are identical so that all the forming stations 20 are adapted to form identical containers 2. According to another embodiment some forming stations 20 are different and enable production of containers 2 with different shapes and/or capacities, for example by modifying the shape of the molding cavities of the forming stations 20 in question. According to this embodiment, as shown in FIG. 1, forming stations 20A adapted to form a first type of containers 2A and forming stations 20B adapted to form a second type of containers 2B are disposed alternately on the forming wheel 24 so that two successive forming stations 20A, 20B form two different containers. The change from one embodiment to the other is simply effected by changing one mold in two on the forming wheel 24 for example. Instead of or in addition to this, the forming stations 20A and 20B could be adapted to receive two different types of preforms, for example preforms made of different materials. The forming stations 20A and 20B could equally be adapted to form containers under different conditions, for example using different pressure curves and/or different forming pressures. It is also understood that more than two different types of forming stations could be provided to form a plurality of different types of containers.

At the exit point 26 of the initial treatment machine the formed containers 2 are taken up by a first transfer device 28. The first transfer device 28 is for example formed by a transfer wheel 30 rotatable about an axis parallel to the rotation axis of the forming wheel 24 and including a plurality of holding elements 32 each adapted to take up a container 2 at the exit point 26 of the initial treatment machine 6. The holding elements 32 are for example formed by clamps adapted to take up the containers by their ring 16. When two types of containers 2A, 2B are produced by the initial treatment machine 6 the first transfer device 28 may be adapted accordingly, if necessary, for example by adapting one holding element 32 in two to the type of container to be taken up, where necessary. Also, in this case the transfer wheel 30 is synchronized with the forming wheel 24 so that the holding elements 32 corresponding to the type of container produced are located at the exit point 26 when that type of container is delivered to the exit point 26 by the initial treatment machine 6.

The first transfer device 28 forms a switch adapted to distribute the containers 2 of the succession of containers 2 to at least one first exit point 34 and/or one second exit point 36 that are separate from one another. This type of switch is known in itself and how a transfer wheel is able selectively to deliver containers at two distinct exit points is described for example in the document EP-1 235 729.

At the first exit point 34 is the first transfer device 28 adapted to transmit some of the containers 2 to the first additional treatment machine 8 and at the second exit point 36 is the first transfer device 28 adapted to transmit other containers 2 to the second additional treatment machine 10.

Thus in the situation where the initial treatment machine 6 produces two types of containers the containers 2A of the first type are transmitted to the first additional treatment machine 8 and the containers 2B of the second type are transmitted to the second additional treatment machine 10. The treatment installation 1 is then in a differentiated treatment configuration.

In the situation in which the initial treatment machine 6 produces only one type of container, one container in two is transmitted to the first additional treatment machine 8 and the other containers are transmitted to the second additional treatment machine 10. The treatment installation 1 is then in a parallel treatment configuration.

It will be noted that in other configurations of the installation to be described hereinafter the first transfer device 28 transmits containers to only one of the two additional treatment machines.

The first additional treatment machine 8 includes a first transfer station 38 and a first filling wheel 40.

The first transfer station 38 is adapted, when in a transfer position, to take up the containers 2 at the first exit point 34 of the first transfer device 28 which also forms the entry point 34 of the first additional treatment machine. To this end, the first transfer station 38 is for example formed by a transfer wheel with no holding elements, of the same type as the transfer wheel 30 of the first transfer device 28. The first transfer station 38 transmits the containers it has taken up to the first filling wheel 40.

The first filling wheel 40 is rotatable about a rotation axis parallel to the rotation axis of the forming wheel 24. The first filling wheel 40 carries a plurality of filling stations 42, or first additional treatment stations. Each filling station 42 is adapted to receive and to fill a container 2. To this end, each filling station 42 includes a container support and a device for filling the container. The filling device is adapted to introduce a filling product into the internal volume of the container 2 via the top opening of the latter. The filling product is for example a liquid, which may be more or less viscous, carbonated or not, and contain solid particles. The filling product may be chilled, at room temperature or hot during filling. The filling stations 42 are carried by the periphery of the first filling wheel 40 so that the filling stations 42 follow a circular path between an entry point 44 and an exit point 46 of the filling wheel 42. Between the entry point and the exit point the filling device is placed in front of the internal volume of the container 2 and the filling product is introduced into the container during the movement of the filling station.

At the exit point 46 a second transfer device 48 takes up the filled containers and removes them from the first additional treatment machine 8 to transfer them to an exit of the forming installation 1 or to the second additional treatment machine 10, as described hereinafter. The second transfer device 48 is for example of the same type as the first transfer device 28, that is to say is formed of a wheel carrying holding elements.

The structure of the second additional treatment machine 10 is substantially identical to that of the first additional treatment machine 8. That is to say the second additional treatment machine 10 comprises a second transfer station 50 and a second filling wheel 52.

In an inactive configuration of the second transfer device and in a transfer position of the second transfer station 50, said second transfer station 50 is adapted to take up the containers 2 at the second exit point 36 of the first transfer device 28 that also forms the entry point 36 of the second additional treatment machine 10. To this end, the second transfer station 38 is for example formed by a transfer wheel having no holding elements, of the same type as the transfer wheel 30 of the first transfer device 28. The second transfer station 50 transmits the containers it has taken up to the second filling wheel 52.

The second filling wheel 52 is rotatable about a rotation axis parallel to the rotation axis of the forming wheel 24. The second filling wheel 40 carries a plurality of filling stations 54, or second additional treatment stations, each adapted to receive and to fill a container 2 between an entry point 56 and an exit point 58 of the second filling wheel 52. The structure of the filling stations 54 is for example the same as that of the filling stations 42 of the first additional treatment machine 8 and will not be described in more detail.

At the exit point 58 of the second additional treatment machine 10 a third transfer device 60 takes up the filled containers and removes them from the first additional treatment machine 8 to transfer them to an exit of the treatment installation 1.

When the first additional processing means 8 and/or the second additional processing means 10 is or are a filling machine, the containers 2 are advantageously capped before exiting the installation (the capping machine(s) are not represented).

The treatment installation 1 according to the invention therefore, starting from an initial treatment machine 6, enables additional treatment to be applied to some of the containers in the first additional treatment machine 8 and another additional treatment to be applied to the other containers in the second additional treatment machine 10 when the treatment installation 1 is in the differentiated treatment configuration or in the parallel treatment configuration. Thus, in these configurations some of the containers follow the path represented in continuous line in FIG. 1 in the first additional treatment machine 8 whereas the others follow the path represented in chain-dotted line in FIG. 1 in the second additional treatment machine 10.

The two additional treatments, namely filling in the example described here, may be different or identical.

By identical is meant that the filling product introduced into the containers during the first and second additional treatments is the same and is injected under the same conditions in the filling stations 42 and 54. By different is meant any type of difference between the two additional treatments, in the nature of the filling product and/or in the filling conditions. For example, the filling product introduced into the containers in the first additional treatment machine 8 is different from the filling product introduced into the containers of the second treatment machine. Instead of or in addition to this, the filling conditions, such as the temperature of the product, the volume of product introduced into each container, etc., are different. Instead of this or in addition to this the filling techniques are different and are chosen from volumetric, flowmetric or weight-based filling. Thus, when the initial treatment machine 6 produces two types of containers 2A, 2B the filling of those containers may be adapted to suit those types of containers, for example in terms of the volume of filling product introduced into the containers. If the containers are identical they can also be filled with different products.

In the differentiated treatment and parallel treatment configurations the treatment installation 1 therefore offers numerous possibilities and a wide choice of container treatments. It will be noted that when the treatment installation 1 is in the parallel treatment configuration and the additional treatments are identical the treatment installation 1 functions with a particularly high throughput because the two additional treatment machines produce the same containers.

The treatment installation 1 may equally be placed in a configuration represented in FIG. 2 for successive treatment of the containers.

In this case, all the containers 2 produced by the initial treatment machine 6 are transferred to the first additional treatment machine 8. This can be achieved by using only alternate filling stations 20, that is to say by not feeding with preforms 4 the forming stations 20 producing containers intended to be transferred to the second additional treatment machine 10. The first transfer device 28, which is synchronized with the initial treatment machine, therefore feeds with containers only the first exit point 34 and the holding elements 32 are empty when they arrive at the second exit point 36. The passage to the successive treatment configuration therefore does not necessitate renewed synchronization of the initial treatment machine 6 and the first transfer device 28. Alternatively, all the forming stations 20 could be used to form containers and means could be provided between the exit of the initial treatment machine and the first transfer device for modifying the pitch between the containers in order to enable the first transfer device to take up all the containers coming from the initial treatment machine.

In the successive treatment configuration the second transfer device 48 is moved from an inactive position in which the second transfer device 48 transfers the containers from the exit point 46 of the first additional treatment machine 8 to the exit of the installation to an active position in which the second transfer device 48 transfers the containers from the exit point 46 of the first additional treatment machine to a second entry point 62 of the filling wheel 52 of the second additional treatment machine 10. The movement from the inactive position to the active position is affected for example by movement in translation of the wheel of the second transfer device 48 so as to move the latter toward the filling wheel 52 of the second additional treatment machine 10, as represented in FIG. 2.

In the successive treatment configuration, after undergoing the first additional treatment, the containers 2 therefore undergo the second additional treatment. In the case of filling, the successive treatment configuration therefore enables partial filling of the containers with a first filling product in the first additional treatment machine 8 after which this filling is completed using a second filling product in the second additional treatment machine 10. The path followed by the containers 2 the successive treatment configuration is represented in solid line in FIG. 2.

After the second filling the containers are evacuated to the exit of the treatment installation by means of the third transfer device 60 at the exit of the filling wheel 52 of the second additional treatment machine 10.

The treatment installation 1 further includes an enclosure 64, partially represented in the figures, in which the treatment machines and transfer devices of the installation are installed in order to isolate them from the outside environment and therefore to maintain them in a controlled atmosphere and to prevent access to the installation when the latter is in normal operation.

The enclosure 64 is moreover provided with an isolation assembly comprising removable walls 66 which when in place isolate the first additional treatment machine 8 (FIG. 4) or the second additional treatment machine 10 (FIG. 3) from the rest of the treatment installation 1 when placed in a cleaning configuration.

In normal operation the isolation assembly is in a retracted configuration in which the containers 2 are able to circulate through the production installation.

When it is wished to clean the first additional treatment machine 10, for example before a change of filling product, walls 66 of the isolation assembly are placed in a first isolation configuration so as to define a first enclosure isolating the first additional treatment machine 8 from the rest of the treatment installation, that is to say from the initial treatment machine 6, from the first transfer device 18, and from the second additional treatment machine 10. In the inactive position the second transfer device 48 is also placed in the isolated space defined by the walls 66 and the enclosure 64. The first transfer station 38 can for example be retracted into a retracted position to house it in the space defined by the walls 66 and the enclosure and to separate the first transfer station 38 from the first exit point 34. Detergent products can therefore be used in the isolated space that houses the first additional treatment machine 8 with no risk of those products reaching the rest of the treatment installation. In this cleaning configuration the treatment installation can continue to function by producing containers and transferring them to the second additional treatment machine 10. In this case containers are produced only in alternate forming stations 20 in order for the first transfer device 18 to supply containers only to the second additional treatment machine 10. The path followed by the containers in this cleaning configuration is represented in solid line in FIG. 4.

When it is required to clean the second additional treatment machine 10, for example before a change of filling product, walls 66 of the isolation assembly are placed in a second isolation configuration so as to form a second enclosure isolating the second additional treatment machine 10 from the rest of the treatment installation, that is to say from the initial treatment machine 6, from the first transfer device 18, from the first additional treatment machine 8, and from the second transfer device 48. To this end the second transfer station 50 is for example retractable into a retracted position to house it in the space defined by the walls 66 and the enclosure and to separate the second transfer station 50 from the second exit point 36. Detergent products can therefore be used in the isolated space housing the second additional treatment machine 10 with no risk of those products reaching the rest of the treatment installation. In this cleaning configuration the treatment installation can continue to function by producing containers and transferring them to the first additional treatment machine 8. In this case, as in the successive treatment configuration, containers are produced only in alternate forming stations 20 so that the first transfer device 18 supplies containers only to the first additional treatment machine 8. The path followed by the containers in this cleaning configuration is represented in solid line in FIG. 3.

The treatment installation described hereinabove is described by way of example only and could be different. Thus, other devices or machines could be added to the installation, such as a labeling machine, a capping machine, etc. The initial treatment machine 6 could be another type of machine, for example a filling machine, the additional treatment machines being capping machines in this case, for example. More generally, the invention may be applied to any type of machines provided that those machines apply successive treatments to the containers.

1. An installation (1) for treating a succession of containers (2), comprising:
at least one machine (6) for the initial treatment of the succession of containers (2), in which the succession of containers (2) is subjected to an initial treatment between an entry point (18) and an exit point (26) of said initial treatment machine (6),
at least one first additional treatment machine (8) and one second additional treatment machine (10) for the additional treatment of the succession of containers (2), each being adapted such that at least some of the succession of containers (2) that have been subjected to the initial treatment are subjected to an additional treatment in the first additional treatment machine (8) and/or in the second additional treatment machine (10), said additional treatment being applied between an entry point (34, 36) and an exit point (46, 58) of each of said first and second additional treatment machines (8, 10),
at least one first transfer device (28) adapted to remove the succession of containers (2) at the exit point (26) of the initial treatment machine (6) and to distribute them selectively to the entry point (34, 36) of the first and/or the second additional treatment machine (8, 10),
a first exit from the installation through which containers treated by the first additional treatment machine can exit, and
a second exit from the installation through which containers treated by the second additional treatment machine can exit, the first exit and the second exit from the installation being separate from one another.

2. The treatment installation as claimed in claim 1, further including an isolation assembly comprising a plurality of mobile walls (66), the isolation assembly being adapted to be actuated at least between:
a first isolation configuration in which at least some of the walls (66) define a first enclosure isolating the first additional treatment machine (8) from an assembly including the initial treatment machine (6), the first transfer device (28) and the second additional treatment machine (10), and
a second isolation configuration in which at least some of the walls (66) define a second enclosure isolating the second additional treatment machine (10) from an assembly including the initial treatment machine (6), the first transfer device (28) and the first additional treatment machine (10).

3. The treatment installation as claimed in claim 2, in which:
the first additional treatment machine (8) includes a first transfer station (38) mobile between:
a transfer position in which the first transfer station (38) enables movement of at least some of the succession of containers (2) from the first transfer device (28) to first additional treatment stations (42) of the first additional treatment machine (8), and
a retracted position in which the first transfer station (38) is placed in the first enclosure in the first isolation configuration; and/or
the second additional treatment machine (10) includes a second transfer station (50) mobile between:
a transfer position in which the second transfer station (50) enables movement of at least one some of the succession of containers (2) from the first transfer device (28) to second additional treatment stations (54) of the second additional treatment machine (10), and
a retracted position in which the second transfer station (50) is placed in the second enclosure in the second isolation configuration.

4. The treatment installation as claimed in claim 1, in which the installation further includes a second transfer device (48) adapted to be actuated between an inactive configuration and an active configuration, the second transfer device (48) when in the active configuration being adapted to take up the succession of containers (2) at the exit point (46) of the first additional treatment machine (8) and to transfer them to the second additional treatment machine (10).

5. The installation as claimed in claim 2, having a successive treatment configuration in which the isolation assembly also has a retracted configuration in which the second transfer device is in the active configuration.

6. The treatment installation as claimed in claim 1, in which the initial treatment machine (6) is a machine for forming a succession of preforms (4) into a succession of containers (2), said succession of preforms (4) being introduced into said forming machine at the entry point (18) and the succession of containers (4) being taken up from said forming machine by the first transfer device (28) at the exit point (26).

7. The treatment installation as claimed in claim 6, in which the forming machine includes a rotatable forming wheel (24) carrying a plurality of stations (20, 20A, 20B) for forming containers (2) each adapted to receive a preform (4) and to form said preform (4) into a container (2) between the entry point (18) and the exit point (26).

8. The treatment installation as claimed in claim 7, in which two successive forming stations (20A, 20B) are adapted to form containers (2A, 2B) that are either different in a differentiated treatment configuration of the installation or identical in a parallel treatment configuration of the installation.

9. The treatment installation as claimed in claim 1, in which the first and second additional treatment machines (8, 10) are container filling machines adapted to introduce a product into the fraction of the succession of containers (2) introduced into each of said filling machines.

10. The treatment installation as claimed in claim 9, in which the first and second additional treatment machines (8, 10) are adapted to introduce a different product into the containers transported in the first and second additional treatment machines (8, 10),
and/or in which the first and second additional treatment machines are filling machines using different filling techniques selected from volumetric, decimetric or weight-based filling.

11. The treatment installation as claimed in claim 9, in which the first additional treatment machine (8) is adapted to introduce a first product into the succession of containers (2) transported in said first machine and the second additional treatment machine (10) is adapted to introduce a second product into said succession of containers (2) containing said first product in a complementary filling configuration of the installation.

12. The treatment installation as claimed in any one of claims 1 to 11, in which the first transfer device (28) includes elements (32) for holding containers (2) distributed at the periphery of a rotatable transfer wheel (30), each holding element (32) being adapted to take up a container (2) at the exit point (26) of the initial treatment machine (6), two successive holding elements (32) being respectively adapted to deliver one transported container to the first additional treatment machine (8) and the other to the second additional treatment machine (10).

13. Use of the installation as claimed in claim 5, in which the first and second additional treatment machines (8, 10) are filling machines adapted to introduce an identical product.

14. A method for changing a treatment applied to containers by a treatment installation, the treatment applied including at least one initial treatment followed by at least one additional treatment, the method comprising:
at least one machine (6) for initial treatment of the succession of containers (2),
at least one first additional treatment machine (8) adapted to apply a first additional treatment and a second additional treatment machine (10) adapted to apply a second additional treatment, each adapted so that at least some of the succession of containers (2) that have undergone the initial treatment undergoes the first additional treatment and/or the second additional treatment,
a first transfer device (28) forming a switch adapted to distribute the containers of the succession of containers to at least one first exit point and/or one second exit point distinct from one another in accordance with a predetermined distribution sequence,
an isolation assembly including a plurality of mobile walls (66), the isolation assembly being adapted to be actuated at least between:
a first isolation configuration in which at least some of the walls (66) define a first enclosure isolating the first additional treatment machine (8) from an assembly including at least the initial treatment machine (6) and the second additional treatment machine (10), and
a second isolation configuration in which at least some of the walls (66) define a second enclosure isolating the second additional treatment machine (10) from an assembly including at least the initial treatment machine (6) and the first additional treatment machine (10),
a passage:
from an earlier phase in which the installation is in the second isolation configuration and the distribution sequence distributes the containers that have received the initial treatment in their entirety to the first additional treatment machine,
to a later stage in which the installation is in the first isolation configuration and the distribution sequence distributes the containers that have received the initial treatment in their entirety to the second additional treatment machine,
wherein the earlier phase includes a step of verifying that the second enclosure satisfies cleanliness criteria required for application of the second treatment, the containers treated during the earlier phase exiting the installation via a first exit in the part of the walls defining the first enclosure,
and in that the later phase includes a step of cleaning the first enclosure, the containers treated during the later phase exiting the installation via a second exit in the part of the walls defining the second enclosure.

15. The installation as claimed in claim 4, having a successive treatment configuration in which the isolation assembly also has a retracted configuration in which the second transfer device is in the active configuration.

16. The treatment installation as claimed in claim 10, in which the first additional treatment machine (8) is adapted to introduce a first product into the succession of containers (2) transported in said first machine and the second additional treatment machine (10) is adapted to introduce a second product into said succession of containers (2) containing said first product in a complementary filling configuration of the installation.

17. Use of the installation as claimed in claim 9, in which the first and second additional treatment machines (8, 10) are filling machines adapted to introduce an identical product.
